(19) United States
(12) Patent Application Publication
(10) Pub. No.: US 2026/0005220 A1
(43) Pub. Date: Jan. 1, 2026

(54) METHOD OF PRODUCING POSITIVE ELECTRODE ACTIVE MATERIAL

(71) Applicant: Prime Planet Energy & Solutions, Inc., Tokyo (JP)

(72) Inventor: Shoji NONAKA, Takasago-shi (JP)

(21) Appl. No.: 19/243,690

(22) Filed: Jun. 20, 2025

(30) Foreign Application Priority Data
Jun. 26, 2024 (JP) 2024-102709

(51) Int. Cl. H01M 4/04; C01G 53/44; H01M 4/525

(52) U.S. Cl. CPC H01M 4/0471; C01G 53/44; H01M 4/525; C01P 2002/50; C01P 2006/40

(57) ABSTRACT

A method of producing a positive electrode active material includes a first step and a second step. In the first step, a mixture of a lithium compound and a transition-metal-containing compound containing a transition metal is calcined with a heater in an oxygen atmosphere at a calcination temperature of 750 to 1000° C. to obtain a lithium transition metal composite oxide. In the second step, microwave is applied to the lithium transition metal composite oxide while the lithium transition metal composite oxide, after the first step, has a temperature of 400° C. or more and less than the calcination temperature in the first step.

### CROSS REFERENCE TO RELATED APPLICATIONS

This nonprovisional application is based on Japanese Patent Application No. 2024-102709 filed on Jun. 26, 2024 with the Japan Patent Office, the entire contents of which are hereby incorporated by reference.

### BACKGROUND OF THE INVENTION

### Field of the Invention

The present disclosure relates to a method of producing a positive electrode active material.

### Description of the Background Art

Japanese Patent Laying-Open No. 2011-210463 discloses that a lithium-containing carbonate is calcined by a combination of heater heating and microwave heating for producing a positive electrode active material for a lithium ion battery.

### SUMMARY OF THE INVENTION

The present disclosure provides a method of producing a positive electrode active material that enables improvement of the resistance of a non-aqueous electrolyte secondary battery while having a small Li-site occupancy.

[1] A method of producing a positive electrode active material, the method including:
a first step of calcining a mixture of a lithium compound and a transition-metal-containing compound containing a transition metal with a heater in an oxygen atmosphere at a calcination temperature of 750 to 1000° C. to obtain a lithium transition metal composite oxide; and
a second step of applying microwave to the lithium transition metal composite oxide while the lithium transition metal composite oxide, after the first step, has a temperature of 400° C. or more and less than the calcination temperature in the first step.

[2] The method of producing a positive electrode active material according to [1], wherein the transition-metal-containing compound is at least one of a nickel-containing hydroxide and a nickel-containing oxide.

[3] The method of producing a positive electrode active material according to [1] or [2], wherein the transition-metal-containing compound contains at least one of Mn and Co.

[4] The method of producing a positive electrode active material according to any one of [1] to [3], wherein the lithium compound is at least one of lithium hydroxide and lithium carbonate.

[5] The method of producing a positive electrode active material according to any one of [1] to [4], wherein
the positive electrode active material contains Li, Ni, Mn, Co, and M, wherein M is one or more metal elements selected from the group consisting of Mg, Ca, Al, Ti, V, Cr, Fe, Cu, Zn, Zr, Nb, Mo, Ta, W, and Y, and
a molar ratio between Li, Ni, Mn, Co, and M is Li:Ni:Mn:Co:M=a:x:y:z:t, where a, x, y, z, and t satisfy 1.0≤a≤1.3, x+y+z+t=1, 0.25≤x<0.9, 0<y≤0.6, 0<z≤0.6, and 0≤t≤0.1.

[6] The method of producing a positive electrode active material according to any one of [1] to [5], wherein the positive electrode active material includes a secondary particle.

[7] The method of producing a positive electrode active material according to any one of [1] to [6], wherein the first step is performed with a continuous calcination furnace in which the mixture is calcined while being transported.

[8] The method of producing a positive electrode active material according to [7], wherein the second step is performed on the lithium transition metal composite oxide removed from the continuous calcination furnace.

[9] The method of producing a positive electrode active material according to [7] or [8], wherein the continuous calcination furnace is a kiln of heater-heating type, and in the kiln in the first step, the mixture is calcined while a saggar containing the mixture is being transported.

The method of producing a positive electrode active material according to any one of [1] to [9], wherein an amount of the microwave applied in the second step is 200 to 1500 Wh per one kilogram of the lithium transition metal composite oxide.

The method of producing a positive electrode active material according to any one of [1] to [10], wherein in the second step, power of the microwave is 4 kW or less and a time for which the microwave is applied is 15 to 90 minutes.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a flowchart illustrating an example of a method of producing a positive electrode active material according to an embodiment.

### DESCRIPTION OF THE PREFERRED EMBODIMENTS

In the present specification, a numerical range such as “m to n” includes the upper limit and the lower limit, unless otherwise specified. That is, “m to n” defines a numerical range of “m or more and n or less.” Any numerical value selected from the numerical range may be defined as a new upper limit or a new lower limit. For example, any numerical value in the numerical range may be combined with any numerical value described in anywhere else of the present specification or in a table thereof or a drawing, for example, to define a new numerical range.

### (Method of Producing Positive Electrode Active Material)

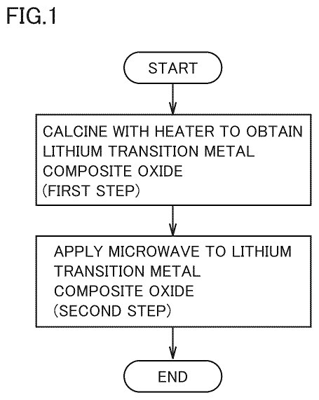

FIG. 1 is a flowchart illustrating an example of a method of producing a positive electrode active material according to an embodiment. A positive electrode active material produced by the method of producing the positive electrode active material of the present embodiment (this method is also referred to as “the present method” hereinafter) is used for a positive electrode plate of a non-aqueous electrolyte secondary battery (also referred to as “secondary battery” hereinafter) such as lithium ion battery.

The positive electrode active material produced by the present method is a lithium transition metal composite oxide (also referred to as “composite oxide” hereinafter) containing lithium and a transition metal. The positive electrode active material may be of the lamellar rock salt type, the spinel type, or the olivine type. The positive electrode active material is preferably of the lamellar rock salt type. The crystal structure of the positive electrode active material can be identified through measurement by means of X-ray diffractometry (also referred to as “XRD method” hereinafter).

While the composition of the positive electrode active material is not particularly limited, it preferably contains Ni, and more preferably contains Ni, Mn, and Co. The positive electrode active material more preferably contains Li, Ni, Mn, Co, and M, and M is one or more metal elements selected from the group consisting of Mg, Ca, Al, Ti, V, Cr, Fe, Cu, Zn, Zr, Nb, Mo, Ta, W, and Y, and the molar ratio between Li, Ni, Mn, Co, and M is Li:Ni:Mn:Co:M=a:x:y:z:t, where a, x, y, z, and t satisfy 1.0≤a≤1.3, x+y+z+t=1, 0.25≤x<0.9, 0<y≤0.6, 0<z≤0.6, and 0≤t≤0.1.

The molar ratio of Li is 1.0≤a≤1.3, may be 1.0≤a≤1.25, may be 1.01≤a≤1.2, may be 1.03≤a≤1.15, or may be 1.04≤a≤1.1. The molar ratio of Ni is 0.25≤x≤0.9, may be 0.3≤x≤0.9, may be 0.4≤x≤0.88, or may be 0.5≤x≤0.85. The molar ratio of Mn is 0<y≤0.6, may be 0.05≤y≤0.5, may be 0.08≤y≤0.3, or may be 0.10≤y≤0.2. The molar ratio of Co is 0<z≤0.6, may be 0<z≤0.5, may be 0.01≤z≤0.3, or may be 0.02≤z≤0.1. The molar ratio of M is Ost≤0.1, may be 0<t≤0.08, may be 0.001≤t≤0.05, or may be 0.002≤t≤0.01. In the case where the positive electrode active material contains two or more metal elements M, the molar ratio of M refers to the total amount of the two or more metal elements.

The composition of the positive electrode active material can be adjusted by means of respective kinds of raw materials used for producing the positive electrode active material and respective contents of the raw materials. The composition of the positive electrode active material can be identified by ICP (Inductively Coupled Plasma) Atomic Emission Spectroscopy (ICP-AES).

The positive electrode active material may be single particles or a secondary particle. The secondary particle is an agglomerate of primary particles. The positive electrode active material preferably includes a secondary particle. The number of agglomerated primary particles in the secondary particle is preferably 50 or more, may be 100 or more, or may be 1000 or more, is usually 5×10⁶ or less, and may be 5×10⁵ or less. The positive electrode active material may further include, in addition to the secondary particle made up of the aforementioned number of agglomerated primary articles, at least one of: a secondary particle made up of an agglomerate of two to ten primary particles; and single particles. The content of the secondary particle made up of an agglomerate of 50 or more primary particles in the positive electrode active material is, for example, 70 to 100% by mass, may be 85 to 98% by mass, or may be 90 to 95% by mass, relative to the total amount, i.e., 100% by mass, of the positive electrode active material. The number of aggregated primary particles in the secondary particle can be adjusted by means of production conditions such as calcination conditions (the calcination temperature, the number of times calcination is performed, the time for which calcination is performed, and the like) for producing the positive electrode active material. The number of agglomerated primary particles included in the secondary particle can be identified on, for example, an SEM image obtained by a scanning electron microscope (also referred to as “SEM” hereinafter).

The Li-site occupancy in the 3b site of the positive electrode active material, for example, is 2 to 4%, may be 2.15 to 3.95%, may be 2.18 to 3.9%, or may be 2.2 to 3.8%. The Li-site occupancy [%] is calculated as the amount of Li present in the site denoted by 3b which is a Wyckoff symbol, on the basis of the measurement data on the positive electrode active material obtained by the XRD method, as described later herein in connection with Examples. The Li-site occupancy in the positive electrode active material can be adjusted by adjusting conditions for calcination in the first step and conditions for applying microwave in the second step, for example.

As illustrated in FIG. 1, the present method includes the following first and second steps. With the present method, the positive electrode active material can be produced through the first step and the second step.

First step: The step of calcining a mixture of a lithium compound and a transition-metal-containing compound containing a transition metal with a heater in an oxygen atmosphere at a calcination temperature of 750 to 1000° C. to obtain a composite oxide.

Second step: The step of applying microwave to the composite oxide while the composite oxide, after the first step, has a temperature of 400° C. or more and less than the calcination temperature in the first step.

It is considered that at least one of the electron arrangement and the crystal distortion of the composite oxide can be adjusted by applying microwave to the composite oxide obtained by calcining the mixture of the lithium compound and the transition-metal-containing compound. Accordingly, it is possible to obtain the positive electrode active material that enables improvement of the resistance of the secondary battery while having a small Li-site occupancy. In contrast, in the case where microwave is not applied, it is difficult to improve the resistance of the secondary battery even when the Li-site occupancy is reduced. Moreover, in the case where heating with a heater and heating with microwave are used in combination in the first step, the raw materials can be heated rapidly so that the time for heating can be shortened. However, this is considered as failing to adjust the electron arrangement and the crystal distortion of the composite oxide, leading to difficulty in improving the Li-site occupancy and the resistance of the secondary battery.

Each of the steps of the present method is hereinafter described in detail.

### First Step

The first step is the step of calcining a mixture of a lithium compound and a transition-metal-containing compound to obtain a composite oxide, and the calcination is performed with a heater. The first step may include the step of obtaining the mixture. The lithium compound and the transition-metal-containing compound are each a compound serving as a raw material for the composite oxide. The mixture is usually in the form of powder or particles.

Examples of the lithium compound include one or more selected from the group consisting of lithium hydroxide, lithium carbonate, lithium nitrate, and lithium acetate. The lithium compound is preferably at least one of lithium hydroxide and lithium carbonate, and more preferably lithium hydroxide. The lithium compound may be an anhydride or a hydrate. In the case where the lithium compound is lithium hydroxide, the lithium hydroxide may be anhydrous lithium hydroxide or may be lithium hydroxide hydrate. Examples of the lithium hydroxide hydrate include, for example, lithium hydroxide monohydrate.

The transition-metal-containing compound preferably contains one or more selected from the group consisting of Ni, Mn, and Co, may contain Ni and at least one of Mn and Co, or may contain Ni, Mn, and Co. The transition-metal-containing compound is preferably at least one of a nickel-containing hydroxide and a nickel-containing oxide, and more preferably contains a nickel-containing oxide, or is a nickel-containing oxide. The nickel-containing compound may contain, besides Ni, a metal element other than Ni, preferably contains, besides Ni, a transition metal element other than Ni, more preferably contains at least one of Mn and Co besides Ni, or may contain Mn and Co, besides Ni.

The nickel-containing hydroxide is preferably a nickel composite hydroxide containing Ni and a metal element other than Ni. The nickel-containing oxide is preferably a nickel composite oxide containing Ni and a metal element other than Ni.

The metal element other than Ni contained in each of the nickel composite hydroxide and the nickel composite oxide is preferably a transition metal element other than Ni, more preferably at least one of Mn and Co, or may be Mn and Co. The nickel-containing compound is preferably a nickel composite oxide.

The mixture may further contain a compound containing M, where M refers to the one defined above. Examples of the compound containing M include one or more selected from the group consisting of an oxide containing M, a hydroxide containing M, a sulfide containing M, an oxyhydroxide containing M, and a halide containing M.

The content of each of the lithium compound, the transition-metal-containing compound, and the compound containing M in the mixture may be set to a content that enables a composite oxide having an intended composition to be obtained.

In the case where the first step includes the step of obtaining the mixture, the step may mix the lithium compound, the transition-metal-containing compound, and, if necessary, the compound containing M, using, for example, a mixer. As the mixer, a general mixer can be used which, for example, may be a jet mill, a ball mill, a rocking mixer, a shaker mixer, a V blender, a ribbon mixer, a Julia mixer, a Loedige mixer, or the like.

The calcination of the mixture in the first step is performed with a heater in an oxygen atmosphere at 750 to 1000° C. The calcination of the mixture is usually performed in a calcination furnace. The calcination furnace is preferably a continuous calcination furnace in which the mixture is calcined while being transported. Examples of the continuous calcination furnace include a kiln of heater-heating type, for example, and examples of the kiln include a roller hearth kiln, a shuttle kiln, a pusher kiln, a tunnel kiln, an externally-heated rotary kiln, and the like.

The mixture may be directly placed in the calcination furnace and calcined, or may be contained in a saggar and the mixture in the saggar placed in the calcination furnace may be calcined. For example, in the case where a kiln of heater-heating type is used as the continuous calcination furnace, the mixture may be calcined in the kiln in the first step while a saggar containing the mixture is being transported in the kiln.

The saggar is made from ceramic. Examples of the material for forming the saggar include one or more selected from the group consisting of alumina, magnesia, zirconium, mullite, silica, carbon, and cordierite, for example.

The oxygen atmosphere in which the mixture is calcined can be generated, for example, by supplying oxygen into the calcination furnace. The first step is preferably performed while oxygen is continuously supplied into the calcination furnace.

The calcination temperature at which the mixture is calcined is 750 to 1000° C., may be 760 to 950° C., may be 770 to 900° C., may be 780 to 880° C., or may be 790 to 850° C. The time for which the calcination is continued at an intended calcination temperature that is any of calcination temperatures within the above-identified range (the time is also referred to as “calcination time” hereinafter) is, for example, 1 to 20 hours, may be 3 to 15 hours, may be 4 to 12 hours, or may be 5 to 10 hours. The calcination time does not include the time for raising the temperature to the intended calcination temperature. The calcination temperature and the calcination time are adjusted to fall within respective ranges specified above, to thereby facilitate acquisition of the positive electrode active material having a small Li-site occupancy and enabling improvement of the resistance of the secondary battery.

As to the calcination in the first step, the mixture having been heated and held at a temperature of less than 750° C. may be calcined at 750 to 1000° C. For example, the mixture may be held at a holding temperature of 300 to 700° C. for 1 to 5 hours and then calcined at 750 to 1000° C. The holding temperature may be 400 to 600° C., or may be 450 to 550° C. The holding time may be 2 to 4 hours or may be 2.5 to 3.5 hours.

### Second Step

The second step is the step of applying microwave to the composite oxide, and the microwave is applied while the composite oxide obtained in the first step has a temperature of 400° C. or more and less than the calcination temperature in the first step. By this application of microwave, at least one of the electron arrangement and the crystal distortion of the composite oxide obtained in the first step can be adjusted, which facilitates acquisition of the positive electrode active material having a small Li-site occupancy and enabling improvement of the resistance of the secondary battery.

The microwave is applied under the condition that the temperature of the composite oxide after the first step has been decreased to a temperature that is lower than the calcination temperature but 400° C. or more, without being decreased excessively. The microwave is applied to the composite oxide calcined in the first step and cooled, before the composite oxide is cooled to be lower than 400° C. The temperature at which the microwave is applied may be 400° C. or more and less than the calcination temperature, may be 400° C. or more and (calcination temperature−50° C.) or less, may be 420° C. or more and (calcination temperature−100)° C. or less, or may be 450° C. or more and (calcination temperature−150° C.) or less. If the microwave is applied at a temperature of more than or equal to the calcination temperature, the composite oxide may be overheated to cause oxygen to be released from the composite oxide, resulting in generation of flames. If the temperature of the composite oxide is decreased excessively, it is difficult to adjust the electron arrangement and the crystal distortion of the composite oxide by application of microwave, resulting in difficulty in improving the Li-site occupancy and the resistance of the secondary battery.

The method of cooling the composite oxide is not particularly limited. The composite oxide may be naturally cooled, or cold air may be blown to the composite oxide. In the case where the first step is performed using a continuous calcination furnace, the second step preferably applies microwave to the composite oxide removed from the continuous calcination furnace. Since the temperature outside the continuous calcination furnace (for example, 30 to 100° C.) is usually lower than the temperature inside the continuous calcination furnace, the composite oxide can be cooled by the temperature difference between the inside and the outside of the continuous calcination furnace. Thus, it is possible to adjust the electron arrangement and the crystal distortion of the composite oxide to decrease the Li-site occupancy and improve the resistance of the secondary battery while preventing overheating of the composite oxide.

The method of applying microwave to the composite oxide removed from the continuous calcination furnace is not particularly limited. Preferably, as described above, the mixture is calcined in the first step while a saggar containing the mixture is being transported in a kiln of heater-heating type, and then microwave is applied to the composite oxide in the saggar removed from the kiln. Thus, the composite oxide in the saggar removed from the kiln can be cooled easily. It is accordingly possible to apply microwave to the cooled composite oxide, prevent overheating of the composite oxide due to application of microwave, and prevent generation of flames due to oxygen released from the composite oxide. The temperature of the composite oxide when microwave is applied to the composite oxide may be adjusted by holding the saggar removed from the kiln for a certain time, or may be adjusted by adjusting the distance between the kiln and position at which microwave is applied, that is, the distance for which the saggar removed from the kiln is transported.

The method of applying microwave is not limited to the above-described one, and the composite oxide discharged from the continuous calcination furnace may be collected in a container and microwave may be applied to the composite oxide in the container, or microwave may be applied to the composite oxide while the composite oxide is being discharged from the continuous calcination furnace, for example.

Microwave may be applied using a microwave irradiation apparatus, and can be applied to the composite oxide placed in the microwave irradiation apparatus. A container in which the composite oxide is collected or a saggar in which the composite oxide is contained may be placed in the microwave irradiation apparatus in which microwave may be applied to the composite oxide.

The amount of the microwave applied in the second step is preferably 200 to 1500 Wh, may be 300 to 1200 Wh, may be 400 to 1100 Wh, or may be 500 to 1000 Wh per one kilogram of the composite oxide. The power of the microwave is preferably 4 kW or less, may be 0.01 to 4 KW, may be 0.05 to 3.5 kW, may be 0.1 to 3 KW, may be 1 to 2.5 kW, or may be 1.2 to 2 kW. The time for which the microwave is applied is preferably 15 to 90 minutes, may be 20 to 80 minutes, may be 25 to 70 minutes, or may be 30 to 60 minutes.

The microwave can be applied in an oxygen atmosphere. The oxygen atmosphere can be generated by supplying oxygen into a space where microwave is to be applied, and the microwave may be applied while oxygen is supplied, for example.

The positive electrode active material obtained by the present method can be used for a positive electrode plate. A method of producing a positive electrode plate can use the positive electrode active material produced by the present method, to produce the positive electrode plate.

The positive electrode plate can have a positive electrode current collector foil and a positive electrode active material layer formed on one side or both sides of the positive electrode current collector foil. The positive electrode active material is included in the positive electrode active material layer, and the positive electrode active material layer can further include at least one of a binder and a conductive auxiliary agent. The positive electrode active material layer can be formed by applying a positive electrode composite material slurry to the positive electrode current collector foil and drying and compressing it, where the positive electrode composite material slurry is obtained by adding a solvent such as N-methyl-2-pyrrolidone (NMP) to the materials for forming the positive electrode active material layer, such as the positive electrode active material, the binder, and the conductive auxiliary agent.

The positive electrode current collector foil is, for example, a metal foil made of an Al material such as Al and Al alloy. Examples of the binder include: a fluororesin such as polyvinylidene difluoride (PVdF) and polytetrafluoroethylene; a cellulose-based resin such as carboxymethyl cellulose (CMC), methyl cellulose, and hydroxypropyl cellulose; and styrene-butadiene rubber, for example, and one or more of them can be used. Examples of the conductive auxiliary agent include a carbon material. Examples of the carbon material include a fibrous carbon such as carbon nanotube, and carbon black, for example, and one or more of them can be used.

The positive electrode plate obtained in the above-described manner can be used for a secondary battery. A method of producing a secondary battery can use the positive electrode plate produced by the above-described method of producing the positive electrode plate, to produce the secondary battery.

The secondary battery can include an electrode assembly including the positive electrode plate, and a non-aqueous electrolyte solution, and may have a battery case that contains the electrode assembly and the non-aqueous electrolyte solution. As the battery case and the non-aqueous electrolyte solution, a known battery case and a known non-aqueous electrolyte solution used in a secondary battery may be used.

The electrode assembly may include the above-described positive electrode plate, a negative electrode plate, and a separator. In the electrode assembly, the positive electrode active material layer of the positive electrode plate and a negative electrode active material layer of the negative electrode plate face each other with the separator interposed in between. The electrode assembly may be of a stacked type in which the positive electrode plate, the negative electrode plate, and the separator are stacked together, or may be of a wound type in which a strip-shaped stack of a strip-shaped positive electrode plate, a strip-shaped negative electrode plate, and a strip-shaped separator is wound. The wound-type electrode assembly may have a flat shape produced by pressing the stack after winding the stack.

Generally, the negative electrode plate has a negative electrode current collector foil and a negative electrode active material layer. The negative electrode current collector foil is, for example, a metal foil made of a copper material such as copper and copper alloy. The negative electrode active material layer includes a negative electrode active material, and may further include a conductive auxiliary agent and a binder, for example. The negative electrode active material layer can be formed by applying a negative electrode composite material slurry to the negative electrode current collector foil and drying and compressing it, where the negative electrode composite material slurry is obtained by adding a solvent such as water to the materials for forming the negative electrode active material layer, such as the negative electrode active material, the binder, and the conductive auxiliary agent.

Examples of the negative electrode active material include carbon-based active materials such as graphite, and metal-based active materials such as Si, SiOx (x=0.5 to 1.5), a composite of Si and C, and Sn, and one or more of them can be used as the negative electrode active material. Examples of the binder include the above-described cellulose-based resin, polyacrylic acid, styrene-butadiene rubber, and the like, and one or more of them can be used as the binder. Examples of the conductive auxiliary agent include the above-described ones.

The separator may have a base material and a functional layer on at least one side of the base material. The base material can be a porous sheet such as film or nonwoven fabric made of resin, such as polyolefin such as polyethylene and polypropylene, polyester, cellulose, polyamide, and the like. The base material may have a single-layer structure or a multilayer structure and, in the case of the multilayer structure, the materials forming respective layers may be identical to or different from each other. Examples of the functional layer include an adhesive layer formed of an adhesive, and a heat-resistant layer including an inorganic filler and a binder, for example.

The non-aqueous electrolyte solution is preferably obtained by adding an electrolyte to a non-aqueous solvent such as organic solvent. Examples of the electrolyte include LiPF₆, LiBF₄, LiClO₄, LiFSO₃, and LiBOB, for example, and one or more of them can be used as the electrolyte. Examples of the non-aqueous solvent include ethylene carbonate, ethyl methyl carbonate, dimethyl carbonate, propylene carbonate, butylene carbonate, and diethyl carbonate, for example, and one or more of them can be used as the non-aqueous solvent.

### EXAMPLES

The present disclosure is hereinafter described more specifically with reference to Examples and Comparative Examples.

### Examples 1 and 2

### (Preparation of Positive Electrode Active Material)

A nickel-containing oxide containing Ni, Co, and Mn at a molar ratio of Ni:Co:Mn=83:5:12 was prepared as a transition-metal-containing compound, and lithium hydroxide monohydrate (average particle size (D50): 10 μm) was prepared as a lithium compound. The transition-metal-containing compound and the lithium compound were mixed so that a mixture having a molar ratio of Li:Ni:Co:Mn=1.06:0.83:0.05:0.12 was obtained. After an alumina crucible serving as a saggar was filled with the mixture, the crucible was placed in an electric furnace and the mixture was calcined to obtain a lithium transition metal composite oxide (first step). The mixture was calcined in the following manner: while the temperature of the mixture was measured by means of an alumina-coated K-type thermocouple inserted into the mixture in the crucible, the mixture was heated initially to 500° C. at an oxygen flow rate of 4 L/min and a temperature increase rate of 5° C./min, then held at 500° C. for 3 hours, thereafter heated to 805° C. at a temperature increase rate of 5° C./min, and calcined at this temperature for the time shown in Table 1.

The crucible was removed from the electric furnace and held outside the electric furnace for a certain time, and 50 g of the lithium transition metal composite oxide was removed from the crucible and placed in a microwave irradiation apparatus, and microwave with 100 W power was applied in an oxygen atmosphere for the application time shown in Table 1, to thereby obtain a positive electrode active material. The temperature of the lithium transition metal composite oxide when microwave was applied to the oxide was in the range of 400° C. or more and less than 805° C. The positive electrode active material had a lamellar rock salt-type structure and was a secondary particle made up of an agglomerate of 50 or more primary particles.

### (Preparation of Positive Electrode Plate)

A positive electrode plate was prepared using the positive electrode active material obtained in the above-described manner. The positive electrode active material, acetylene black (AB) serving as a conductive auxiliary agent, and polyvinylidene difluoride (PVdF) serving as a binder were prepared at a mass ratio of (positive electrode active material):AB:PVdF=100:1:1, and they were mixed with N-methyl-2-pyrrolidone (NMP) to thereby prepare a positive electrode composite material slurry. The positive electrode composite material slurry was applied to an aluminum foil serving as a positive electrode current collector foil, dried, compressed, and thereafter cut into a predetermined size to thereby obtain a positive electrode plate.

### (Preparation of Negative Electrode Plate)

A negative electrode active material which was a mixture of graphite and SiO was prepared, and styrene-butadiene rubber (SBR) and carboxymethyl cellulose (CMC) were prepared as a binder. The negative electrode active material, SBR, and CMC were prepared at a mass ratio of (negative electrode active material):SBR:CMC=100:1:1, and they were mixed with water to thereby prepare a negative electrode composite material slurry. The negative electrode slurry was applied to a copper foil serving as a negative electrode current collector foil, dried, compressed, and thereafter cut into a predetermined size to thereby obtain a negative electrode plate.

### (Preparation of Non-Aqueous Electrolyte Secondary Battery)

A separator having a three-layer structure: polypropylene/polyethylene/polypropylene was prepared. The positive electrode plate and the negative electrode plate were stacked with the separator interposed in between to thereby obtain an electrode assembly. At the opposite ends of the electrode assembly, a positive electrode tab and a negative electrode tab were exposed, respectively, the positive electrode tab was formed of an aluminum foil in a region of the positive electrode current collector foil where the positive electrode active material layer was not formed, and the negative electrode tab was formed of a copper foil in a region of the negative electrode current collector foil where the negative electrode active material layer was not formed. The positive electrode tab was welded to an aluminum plate serving as an external positive electrode current collector, and the negative electrode tab was welded to a copper plate serving as an external negative electrode current collector, the electrode assembly was thereafter inserted into an exterior package of an aluminum laminate film, and the film was welded so as to form a liquid injection port. After a non-aqueous electrolyte solution was injected from the liquid injection port, the liquid injection port was sealed to thereby obtain a battery.

The non-aqueous electrolyte solution was prepared by dissolving lithium hexafluorophosphate (LiPF₆) serving as an electrolyte at a concentration of 1 mol/L in a solvent mixture of ethylene carbonate (EC) and ethyl methyl carbonate (EMC) mixed at a volume ratio of EC:EMC=1:3.

### Comparative Example 1

A positive electrode active material was obtained in a similar manner to the procedure described above in connection with Examples 1 and 2, except that microwave was not applied. The positive electrode active material had a lamellar rock salt-type structure and was a secondary particle made up of an agglomerate of 50 or more primary particles. A positive electrode plate and a non-aqueous electrolyte secondary battery were obtained in a similar manner to the procedure described above in connection with Examples 1 and 2, except that this positive electrode active material was used.

### Comparative Example 2

A positive electrode active material was obtained in a similar manner to the procedure described above in connection with Examples 1 and 2, except that the calcination time for which the mixture was calcined at 805° C. was changed to the time shown in Table 1, and that microwave was not applied. The positive electrode active material had a lamellar rock salt-type structure and was a secondary particle made up of an agglomerate of 50 or more primary particles. A positive electrode plate and a non-aqueous electrolyte secondary battery were obtained in a similar manner to the procedure described above in connection with Examples 1 and 2, except that this positive electrode active material was used.

### [Calculation of Li-Site Occupancy]

The positive electrode active materials obtained in the Examples and Comparative Examples were subjected to X-ray diffraction measurement by means of an X-ray diffractometer (“SmartLab” manufactured by Rigaku Corporation). By Rietveld analysis of measurement data obtained by the X-ray diffraction measurement, the amount of Ni present in the sites denoted by Wyckoff symbols 3a and 3b (these sites may be referred to hereinafter as “3a site” and “3b site” respectively) was calculated. At this time, the Li composition in the 3a site and the Ni composition in the 3b site were variable, and the compositions of Co and Mn were invariable. The amount of Li present in the 3b site was calculated as the Li-site occupancy [%]. The results are shown in Table 1.

### [Measurement of Resistance]

In an activation charging process for the secondary batteries obtained in the Examples and Comparative Examples, the secondary batteries were charged to 4.2 V at a current rate of 0.1 C, and thereafter discharged to 3.0 V at 0.1 C. Subsequently, under a temperature condition of 25° C., the secondary batteries were charged until the state of charge (SOC) reached 50%. After a rest for one hour, the batteries were discharged at a current value of 1 C for 10 seconds, and resistance R was calculated by the following formula, where V0 [V] was an OCV (open circuit voltage) immediately before the discharging, and V1 [V] was the voltage after 10 seconds. As resistance R is smaller, the resistance of the secondary battery is improved to a greater extent. The results are shown in Table 1.

$$Resistance R [ Ω ] = ( V 0 - V 1 ) [ V ] / current value [ A ] of 1 C$$

TABLE 1

| | Calcination | Microwave | Li-site | |
|---|---|---|---|---|
| | Time | Application Time | Occupancy | Resistance |
| | [hr] | [min] | [%] | [Ω] |
| Example 1 | 6 | 20 | 3.70 | 0.0074 |
| Example 2 | 6 | 30 | 2.23 | 0.0038 |
| Comparative | 6 | — | 4.72 | 0.0133 |
| Example 1 | | | | |
| Comparative | 10 | — | 2.50 | 0.0086 |
| Example 2 | | | | |

In Examples 1 and 2, respective amounts of microwave applied per one kilogram of the lithium transition metal composite oxide were 667 Wh and 1000 Wh, respectively.

While the embodiments of the present invention have been described, it should be construed that the embodiments disclosed herein are given by way of illustration in all respects, not by way of limitation. It is intended that the scope of the present invention is defined by claims, and encompasses all modifications equivalent in meaning and scope to the claims.

What is claimed is:

1. A method of producing a positive electrode active material, the method comprising:
a first step of calcining a mixture of a lithium compound and a transition-metal-containing compound containing a transition metal with a heater in an oxygen atmosphere at a calcination temperature of 750 to 1000° C. to obtain a lithium transition metal composite oxide; and
a second step of applying microwave to the lithium transition metal composite oxide while the lithium transition metal composite oxide, after the first step, has a temperature of 400° C. or more and less than the calcination temperature in the first step.

2. The method of producing a positive electrode active material according to claim 1, wherein the transition-metal-containing compound is at least one of a nickel-containing hydroxide and a nickel-containing oxide.

3. The method of producing a positive electrode active material according to claim 2, wherein the transition-metal-containing compound contains at least one of Mn and Co.

4. The method of producing a positive electrode active material according to claim 1, wherein the lithium compound is at least one of lithium hydroxide and lithium carbonate.

5. The method of producing a positive electrode active material according to claim 1, wherein
the positive electrode active material contains Li, Ni, Mn, Co, and M, wherein M is one or more metal elements selected from the group consisting of Mg, Ca, Al, Ti, V, Cr, Fe, Cu, Zn, Zr, Nb, Mo, Ta, W, and Y, and
a molar ratio between Li, Ni, Mn, Co, and M is Li:Ni:Mn:Co:M=a:x:y:z:t, where a, x, y, z, and t satisfy 1.0≤a≤1.3, x+y+z+t=1, 0.25≤x≤0.9, 0<y≤0.6, 0<z≤0.6, and 0≤t≤0.1.

6. The method of producing a positive electrode active material according to claim 1, wherein the positive electrode active material includes a secondary particle.

7. The method of producing a positive electrode active material according to claim 1, wherein the first step is performed with a continuous calcination furnace in which the mixture is calcined while being transported.

8. The method of producing a positive electrode active material according to claim 7, wherein the second step is performed on the lithium transition metal composite oxide removed from the continuous calcination furnace.

9. The method of producing a positive electrode active material according to claim 7, wherein
the continuous calcination furnace is a kiln of heater-heating type, and
in the kiln in the first step, the mixture is calcined while a saggar containing the mixture is being transported.

10. The method of producing a positive electrode active material according to claim 1, wherein an amount of the microwave applied in the second step is 200 to 1500 Wh per one kilogram of the lithium transition metal composite oxide.

11. The method of producing a positive electrode active material according to claim 1, wherein in the second step, power of the microwave is 4 kW or less and a time for which the microwave is applied is 15 to 90 minutes.
